(19) United States
(12) Patent Application Publication
(10) Pub. No.: US 2023/0249495 A1
(43) Pub. Date: Aug. 10, 2023

(54) Tire Traction Attachment Device

(71) Applicant: Zachary Ducote, Plaucheville, LA (US)

(72) Inventor: Zachary Ducote, Plaucheville, LA (US)

(21) Appl. No.: 17/666,073

(22) Filed: Feb. 7, 2022

(51) Int. Cl. B60B 15/10; B60B 15/08

(52) U.S. Cl. CPC B60B 15/10; B60B 15/08

(57) ABSTRACT

A tire traction attachment device for a plurality of support beams being inserted into a tire and adjustable arms providing traction includes a base. The base has a peripheral surface and a back surface. A plurality of spike holders is positioned in a circular pattern relative to the base. Each spike of a plurality of spikes is inserted into a respective one of each of the spike holders. Each of the spikes has telescopic functions for adjusting the position relative to each of the spike holders. A plurality of support beams has a distal end and a proximal end relative to the base. The proximal end of each of the support beams is coupled to the back surface of the base and the distal end of each of the support beams is coupled to a mounting base.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to wheel traction attachment devices and more particularly pertains to a new wheel traction attachment device using a plurality of support beams inserted into a tire and adjustable arms providing traction.

### (2) Description of Related Art Including Information Disclosed Under 37 CFR 1.97 and 1.98

The prior art relates to wheel traction attachment devices. The prior art relates to a variety of wheel traction attachment devices having a plurality of extendable arms. Known prior art lacks a wheel traction attachment device comprising of a plurality of extendable arms and an offset base being attached to the device by support beams and inserted into a tire.

### (h) BRIEF SUMMARY OF THE INVENTION

An embodiment of the disclosure meets the needs presented above by generally comprising a base. The base has a peripheral surface and a back surface. The base is circular and has a center. A plurality of spike holders is positioned in a circular pattern relative to the base. The circular pattern of each of the spike holders is positioned equal distance from each other and equal distance from the center of the base. Each of the spike holders has a rectangular body and a hollow interior. A side of each of the spike holders is coupled to the peripheral surface of the base. Each spike of a plurality of spikes is inserted into a respective one of each of the spike holders. Each of the spikes has telescopic functions for adjusting the position relative to each of the spike holders. A plurality of support beams has a distal end and a proximal end relative to the base. The proximal end of each of the support beams is coupled to the back surface of the base and the distal end of each of the support beams is coupled to a mounting base. The mounting base is circular and concentric to the base. The mounting base and the plurality of support beams are configured for being inserted into the center of a tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a tire traction attachment device according to an embodiment of the disclosure.

FIG. 2 is a back view of an embodiment of the disclosure.

FIG. 3 is a front view of an embodiment of the disclosure.

FIG. 4 is a side view of an embodiment of the disclosure.

FIG. 5 is an in-use view of an embodiment of the disclosure.

### (j) DETAILED DESCRIPTION OF THE INVENTION

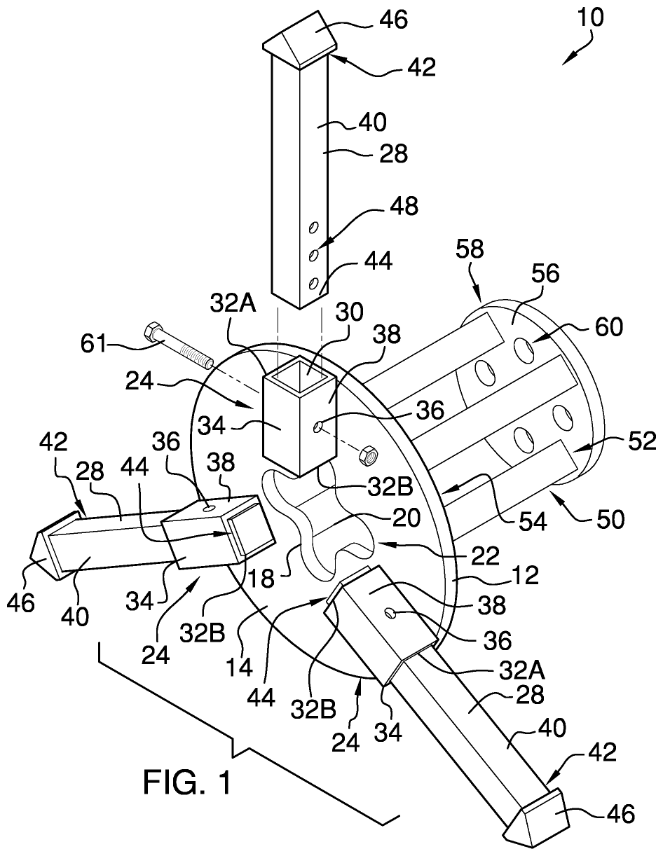

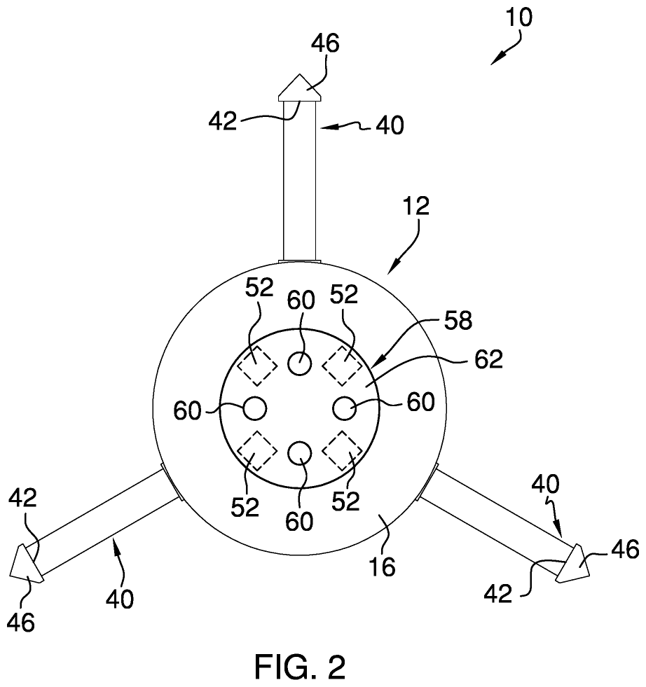

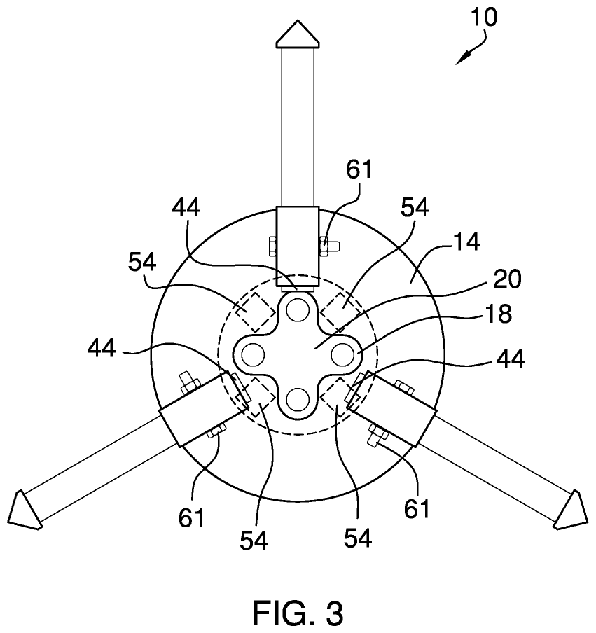

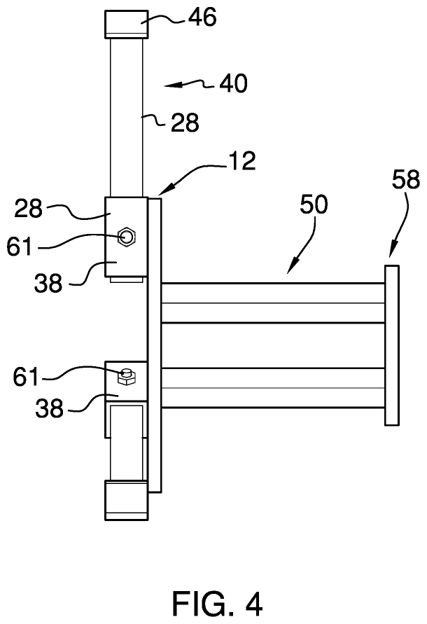

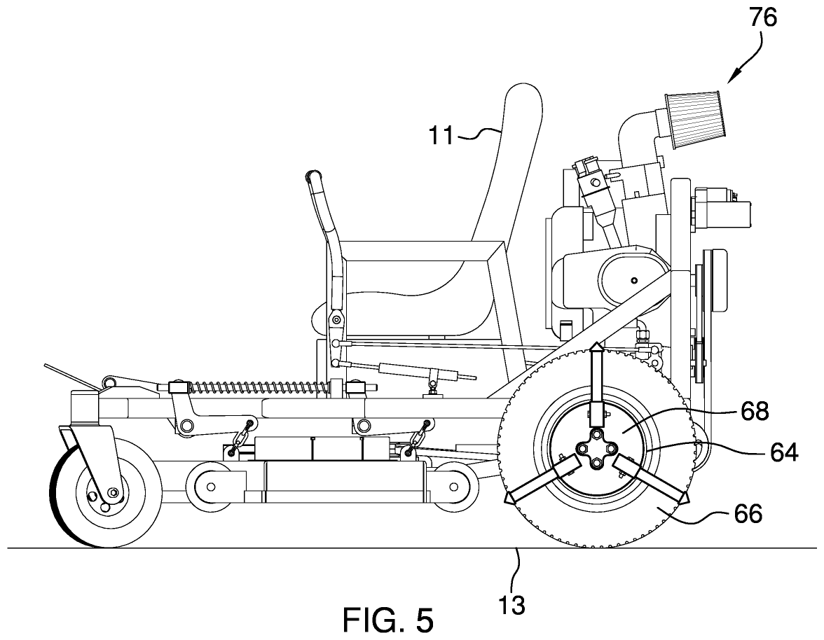

With reference now to the drawings, and in particular to FIGS. 1 through 5 thereof, a new wheel traction attachment device embodying the principles and concepts of an embodiment of the disclosure and generally designated by the reference numeral 10 will be described.

As best illustrated in FIGS. 1 through 5, the tire traction attachment device 10 generally comprises a base 12. The base 12 is circular. The base 12 has a peripheral surface 14 and a back surface 16. The base 12 has a cut out 18. The cut 18 out is positioned in a center 20 of the base 12. The cut out 18 defines a window 22 for a user 11 to see through. The base 12 provides a structure to hold a plurality of spike holders 24.

The plurality of spike holders 24 is positioned in a circular pattern 26 relative to the base 12. The circular pattern 26 is each of the spike holders 24 being positioned equal distance from each other and positioned equal distance from the center 20 of the base 12. Each of the spike holders 24 has a purpose of housing each spike 40 of a plurality of spikes 40.

Each of the spike holders 24 has a rectangular body 28. Each of the spike holders 24 has a hollow interior 30 and a pair of ends 32. Each of the ends 32 is an open end. A side 34 of each of the spike holders 24 is coupled to the peripheral surface 14 of the base 12. Each of the spike holders 24 has an aperture 36. The aperture 36 is circular and is positioned on a perpendicular side 38 of each of the spike holders 24. The aperture 36 has a purpose of holding a screw 61.

Each spike 40 of the plurality of spikes 40 has a rectangular body 28. Each of the spikes 40 is complementary to each of the spike holders 24. Each of the spikes 40 is inserted into a respective one of each of the spike holders 24. Each of the spikes 40 has a distal end 42 and a proximal end 44 relative to the center 20 of the base 12. The proximal end 44 is a free end and the distal end 42 has a spear 46.

The proximal end is inserted into an end 32A of the pair of ends 32 and inserted out of an end 32B of the pair of ends 32 of each of the spike holders 24. The spear 46 has a triangular shape and is configured for engaging with the ground 13. Each of the spikes has a plurality of holes 48. Each of the holes 48 defines a space for the screw 61 to be interested into and hold each of the spikes 40 in a fixed position relative to each of the spike holders 24.

Each support beam 50 of a plurality of support beams 50 has a distal end 52 and a proximal end 54 relative to the base 12. The proximal end 54 is coupled to the back surface 16 of the base 12. The plurality of support beams 50 is positioned on the back surface 16 in a circular pattern 26 relative to the base 12.

The distal end 52 of each of the support beams 50 is coupled to a forward surface 56 of a mounting base 58. The mounting base 58 is circular. The plurality of support beams 50 is positioned on the mounting base 58 in a circular pattern 26 relative to the base 12.

The mounting base 58 has a plurality of mounting holes 60. Each of the mounting holes 60 defines a space where mounting screws 63 can be inserted. The plurality of mounting holes 60 is positioned in a circular pattern 26 relative to the mounting base 58.

In use, a mounting surface 62 of the mounting base 58 is inserted into an interior center 64 of a tire 66. The mounting surface 62 abuts the inboard face 68 of a vehicle 70. The plurality of support beams 50 are nested within the interior center 64 of the tire 66. The user 11 inserts the mounting screws 63 into a respective one of each of the mounting holes 60. Each of the spikes 40 is adjusted within a respective one of each of the spike holders 24. The user 11 inserts a screw 61 into the aperture 36 of each of the spike holders 24 and into a hole 48A of the plurality of holes 48 of each of the spikes 40. The screw 61 inserted into both the aperture 36 and the hole 48A is configured for maintaining each of the spikes 40 in a fixed positioned relative to each of the spike holders 24. As the tire 66 of the vehicle 70 rotates, the spears 46 of each of the spikes 40 impale the ground 13 to provide traction to the tire 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. a tire traction attachment device comprising:
a base, said base having a peripheral surface and a back surface;
a plurality of spike holders, each of said spike holders having an hollow interior, a side of each of said spike holders being coupled to said peripheral surface of said base;
a plurality of spikes, each of said spikes being configured for being inserted into a respective one of each of said spike holders, each of said spikes having telescopic functionality for adjustment of position relative to each of said spike holders;
a plurality of support beams, each of said support beams having a proximal end relative to said base and a distal end relative to said base, said proximal end of each of said support beams being coupled to said back surface of said base; and
a mounting base, said mounting base having a forward surface and a mounting surface, said distal end of each of said support beams being coupled to said forward surface of said mounting base.

2. The tire traction attachment device of claim 1, further comprising said base being circular.

3. The tire traction attachment device of claim 1, further comprising said base having a cut out, said cut out being positioned in a center of said base, said cut out defining a window for a user to look through.

4. The tire traction attachment device of claim 1, further comprising each of said spike holders having a rectangular body, each of said spike holders having a hollow interior, each of said spike holders having a pair of open ends configured for allowing an element to be inserted into said hollow interior.

5. The tire traction attachment device of claim 1, further comprising each of said spike holders having an aperture, said aperture of each of said spike holders being positioned in a side of each of side spike holders.

6. The tire traction attachment device of claim 1, further comprising said plurality of spike holders being positioned in a circular pattern relative to said base, said circular pattern being each of said spike holder being equal distance from each other and from said center of said base.

7. The tire traction attachment device of claim 1, further comprising each of said spikes having a rectangular body, each of said spikes being complementary to each of said spike holder.

8. The tire traction attachment device of claim 1, further comprising each of said spikes having a proximal end relative to said center of said base and a distal end relative to said center of said base, said proximal end being a free end and said distal end having a spear, said spear being a triangular shape, said spear being configured for engaging with the ground.

9. The tire traction attachment device of claim 1, further comprising each of said spikes having a plurality of holes, each of said holes defines a space for a screw to be inserted.

10. The tire traction attachment device of claim 1, further comprising said plurality of support beams being positioned in said circular pattern relative to said base.

11. The tire traction attachment device of claim 1, further comprising said plurality of support beams being configured for being inserted into a center of a tire.

12. The tire traction attachment device of claim 1, further comprising said mounting base being circular, said mounting base being concentric relative to said base.

13. The tire traction attachment device of claim 1, further comprising said mounting base having a plurality of mounting holes, said plurality of mounting holes being positioned in said circular pattern relative to said base, each of said mounting holes defining a space for a mounting screw to be inserted.

14. The tire traction attachment device of claim 1, further comprising said distal end of each of said support beams being coupled to said forward surface of said mounting base, said plurality of support beams being positioned in said circular pattern relative to said base.

15. A tire traction attachment device comprising:
a base, said base being circular, said base having a peripheral surface and a back surface, said base having a cut out, said cut out being positioned in a center of said base, said cut out defines a window for a user to look through;
a plurality of spike holders, each of said spike holders having a rectangular body, each of said spike holders having a hollow interior, each of said spike holders having a pair of open ends, each of said spike holders having an aperture, said aperture of each of said spike holders being positioned in a side of each of side spike holders, a side of each of said spike holders being coupled to said peripheral surface of said base, said plurality of spike holders being positioned in a circular pattern relative to said base, said circular pattern being each of said spike holder being equal distance from each other and from said center of said base;
a plurality of spikes, each of said spikes having a rectangular body, each of said spike being complementary to each of said spike holder, each of said spikes being configured for being inserted into a respective one of each of said spike holders, each of said spikes having telescopic functionality for adjustment of position relative to each of said spike holders, each of said spikes having a proximal end relative to said center of said base and a distal end relative to said center of said base, said proximal end being a free end and said distal end having a spear, said spear being a triangular shape, said spear being configured for engaging with the ground, each of said spikes having a plurality of holes, each of said holes defines a space for a screw to be inserted;
a plurality of support beams, each of said support beams having a proximal end relative to said base and a distal end relative to said base, said proximal end of each of said support beams being coupled to said back surface of said base, said plurality of support beams being positioned in said circular pattern relative to said base, said plurality of support beams being configured for being inserted into a center of a tire; and
a mounting base, said mounting base having a forward surface and a mounting surface, said mounting base being circular, said mounting base being concentric relative to said base, said mounting base having a plurality of mounting holes, said plurality of mounting holes being positioned in said circular pattern relative to said base, each of said mounting holes defining a space for a mounting screw to be inserted, said distal end of each of said support beams being coupled to said forward surface of said mounting base, said plurality of support beams being positioned in said circular pattern relative to said base.
